(19) United States
(12) Patent Application Publication
(10) Pub. No.: US 2009/0094105 A1
(43) Pub. Date: Apr. 9, 2009

(54) CONTENT EMBEDDED TOOLTIP ADVERTISING

(75) Inventors: Alexander G. Gounares, Kirkland, WA (US); David M. Chickering, Bellevue, WA (US); Eric J. Horvitz, Kirkland, WA (US); Michael Connolly, Seattle, WA (US); Lili Cheng, Bellevue, WA (US); Kamal Jain, Bellevue, WA (US); George P. Moromisato, Seattle, WA (US)

Correspondence Address: AMIN, TUROCY & CALVIN, LLP, 127 Public Square, 57th Floor, Key Tower, CLEVELAND, OH, 44114, US

(73) Assignee: Microsoft Corporation, Redmond, WA (US)

(21) Appl. No.: 11/868,749

(22) Filed: Oct. 8, 2007

(51) Int. Cl. G06Q 30/00

(52) U.S. Cl. 705/14

(57) ABSTRACT

Contextual advertisements embedded within content having tooltip type display functionality are provided where content can be evaluated for possible points for insertion of the advertisements. The content can be evaluated against a list of trigger points indicating advertisement should be inserted along with instructions to embed the advertisements. Using this information, the content can be modified to embed appropriate advertising. Upon returning the content, a viewer thereof can view the content normally, but certain events with respect to the trigger points can cause tooltip type display of the advertisement (such as hovering a cursor over the trigger point). In this regard, trigger points, such as keywords, having associated pop-up advertisements can be underlined or otherwise identified.

### BACKGROUND

The evolution of computers and networking technologies from high-cost, low performance data processing systems to low cost, high-performance communication, problem solving, and entertainment systems has provided a cost-effective and time saving means to lessen the burden of performing every day tasks such as correspondence, bill paying, shopping, budgeting information and gathering, etc. For example, a computing system interfaced to the Internet, by way of wire or wireless technology, can provide a user with a channel for nearly instantaneous access to a wealth of information from a repository of web sites and servers located around the world. As such, online advertising on such sites is becoming increasingly popular to a point where today almost anyone can easily implement contextual advertising on their website and receive compensation for facilitating clicking on the advertisements. However, advertisements are often intrusive as the aim is to obtain as much exposure for the advertisement as possible. To this end, ads are often pasted at the top of a website restricting much of the viewing area. Market trends in the last few years have gone to moving the advertisements to the sides of pages and in other corners, which offer more real estate and still heavily constrain the viewing area for the web page.

Often in technical documents, words are used that are ordinarily understood by highly skilled artisans. To the average or skilled (but not necessarily highly skilled) reader, the terms can often cause confusion and/or the reader may not remember exactly what the term refers to in the context used. To aid with this, without cluttering the documents with explanations ordinarily understood, tooltips have been developed to provide a mechanism for displaying a pop-up box upon hovering a mouse cursor over some words in a document; the box can disappear when the cursor moves away from the word. Additionally, this behavior can be seen in software applications for different buttons, menu options, and the like available for selection. Tooltips allow for more efficient and verbose display of items such that those who understand what is shown need not be cluttered with explanations while those who may be using software or reading technical information for the first time can decipher such by hovering a mouse cursor over items to receive the tooltip boxes offering further explanation.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Contextual advertisements embedded in content as displayable tooltips are provided where advertising information can be associated with certain elements in the content. Triggers can be identified within the content as points of insertion for the advertisements and code to display them. The triggers can match to one or more stored items that associate the triggers with the advertising information, and the advertising information can be embedded at the trigger locations, for example. In this regard, the trigger can be used as an anchor for the embedded code. Thus, the content can be displayed normally to a requesting entity, but hovering a cursor over one or more triggers can cause a tooltip type advertisement to be displayed. It is to be appreciated that the content can be displayed at a viewing end such that the display engine can properly handle the code to display the advertisement tooltips.

In one embodiment, the content can be a web page, for example. The web page can be analyzed against a storage of keywords and associated advertisements for the keywords to determine insertion points for advertisements. Where words of the web page match words in the storage, the advertisement relating to the word (and the code to display such) can be embedded within the web page. For example, context can also be utilized to choose appropriate advertising as different words can have different meanings (and/or be associated with different ads) in different contexts. The advertisement can be embedded along with scripting code to display the advertisement in a tooltip display manner, for example. Thus, when the web page is returned, the rendering engine can interpret and properly display the web page and the advertisements as tooltips when a trigger keyword is hovered over with a mouse cursor, for example.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a block diagram of an exemplary system that associates advertisements with content.

FIG. 2 illustrates a block diagram of an exemplary system that associates advertisements upon requests for content.

FIG. 3 illustrates a block diagram of an exemplary system that locates portions of content for insertion of advertising.

FIG. 4 illustrates a block diagram of an exemplary system that embeds advertisements within content.

FIG. 5 illustrates a block diagram of an exemplary system that embeds advertisements within web pages upon request for the web pages.

FIG. 6 illustrates an exemplary flow chart for embedding advertisements within content upon request for the content.

FIG. 7 illustrates an exemplary flow chart for embedding advertisements and display code within web pages upon request for the web pages.

FIG. 8 illustrates an exemplary flow chart for receiving and displaying content with embedded advertisement display code.

FIG. 9 is a schematic block diagram illustrating a suitable operating environment.

FIG. 10 is a schematic block diagram of a sample-computing environment.

### DETAILED DESCRIPTION

Embedding tooltip contextual advertisements within content is provided where actions on the content can reveal the advertisements. For example, moving a mouse cursor over certain content in a document can reveal a tooltip type box comprising an advertisement. It is to be appreciated that the content and advertisement can be text, such as in a web page, one or more images, videos, tags, and the like, for example. Additionally, advertisement can be provided in other ways corresponding to actions on the content; for example, audio can be played upon moving a mouse cursor over a portion of the content in one embodiment. Thus, advertisements can be tied to certain keywords, other key content (e.g. triggers), metadata, microformats, and/or the like, such that a request for content can result in the requested content being evaluated for certain keywords or key content/triggers with which the advertisement tooltip code can be embedded.

For example, in one embodiment, a server delivering web pages can receive a request for a certain page, or code to generate such a page for example. The server can evaluate the page for certain key content (e.g. a keyword, metadata, microformats, and the like) against a database that stores such content along with information leading to an advertisement (such as a link). Upon locating key content in the web page, the server can embed code that exposes a tooltip displaying the advertisement upon action to the content. For example, the action can be a mouse-over, a click, a mouse in the vicinity, a portion of the web page exposed in a browser window, and/or the like. Thus, when the server delivers the web page, the tooltip code is resident in the page and properly executes for the given action on the content. In this regard, tooltip type advertising is achieved for certain key content in the web pages.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

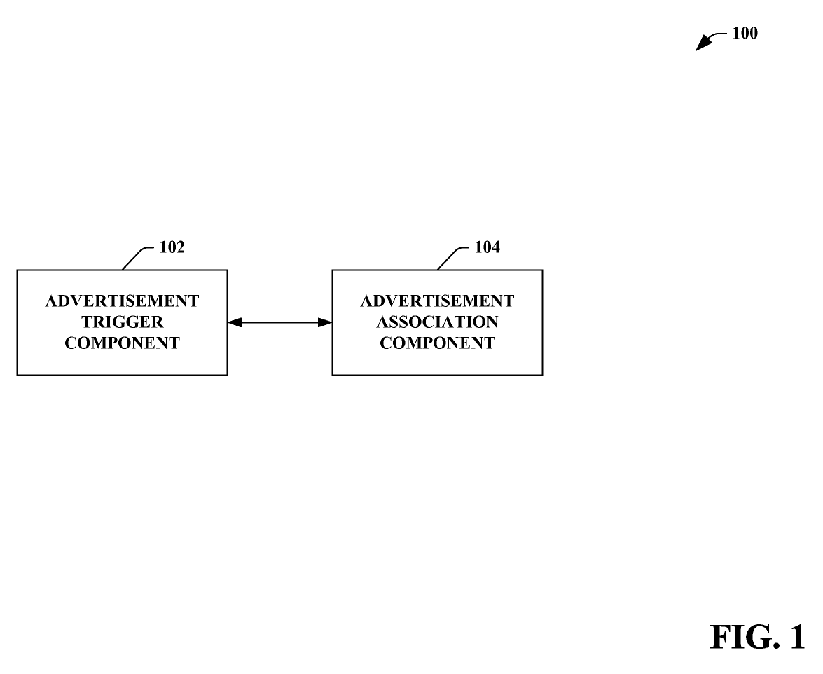

Now turning to the figures, FIG. 1 illustrates a system 100 that facilitates associating advertisements with content. An advertisement trigger component 102 is provided that can evaluate content to detect portions thereof that can be associated with a contextual advertisement; an advertisement association component 104 is provided that can provide the association. In one embodiment, the advertisement trigger component 102 can analyze a portion of text and code associated therewith for keywords related to available advertisements, for example. If the keywords exist in the content, the advertisement association component 104 can embed text and/or code to display the advertisement(s) as a result of certain actions with respect to the content.

The advertisement trigger component 102 can evaluate numerous types of media for insertion of advertisement data. For example, the content can be text, hypertext markup language (HTML), structured text such as extensible markup language (XML), document text, images, animations, videos, tags, metadata, and the like. The advertisement trigger component 102 can analyze the content for triggers indicating possible points for insertion of the advertisement information. It is to be appreciated that the triggers can be inferred from the content, such as by employing inference techniques and/or text/content matching, or the triggers can be explicit in the content, such as metadata or microformats indicating context for advertisements, explicit advertisements to be used (and code therefor), and/or insertion points for the advertisements. For example, one or more advertisements can be provided to the advertisement trigger component 102 along with one or more triggers that can be utilized to find a point of insertion. In one embodiment, the triggers can be single words (e.g. keywords), sentences, paragraphs, combinations of words (sequential or sporadic), code sections, matched images, data tags, specific metadata, and the like. When the advertisement trigger component 102 detects a trigger in the content, it can leverage the advertisement association component 104 to embed advertisement information, for example.

In this regard, portions of the content can be used as an anchor, and the advertisement association component 104 can implement the advertisement around the content portion. For example, the content portion can appear untouched, but can display a tooltip advertisement upon an action to the content (or the portion). For example, moving the mouse over the portion and/or bringing the portion of content within window view can be such actions to cause display of the tooltip advertisement. The functionality of the advertisement association component 104 embedded code can be defined by that available in the content format. For example, where the content is in HTML, the advertisement association component 104 can utilize HTML to embed the advertisement for seamless integration of the tooltip advertising. It is to be appreciated that additional code can be embedded to facilitate certain functions, such as executable code implemented within the content code, for example. In one embodiment, scripting code can be embedded within HTML content to facilitate certain actions, such as the mouse-over and window view functionalities mentioned above.

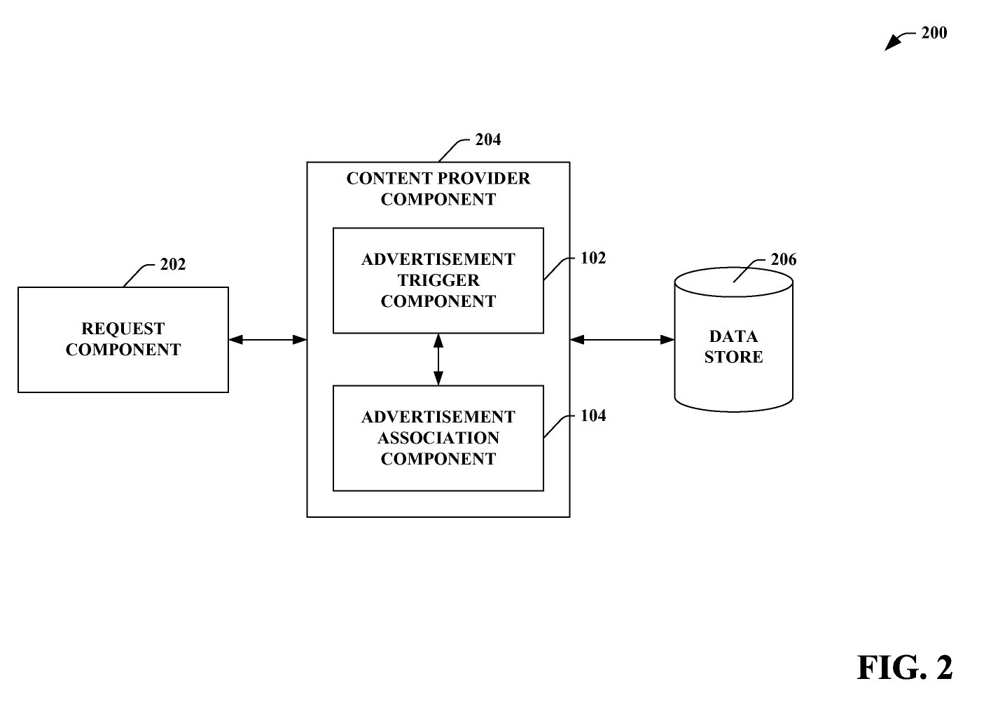

Referring to FIG. 2, a system 200 for associating advertisements with content from a content provider is shown. A request component 202 is provided that requests content from a content provider component 204. The content provider component 204 comprises an advertisement trigger component 102 that can analyze content for triggers that indicate advertisement insertion points and an advertisement association component 104 that can embed advertising information and/or code upon observing such a trigger. Additionally, a data store 206 is provided that can store the content provided by the content provider component 204, for example. Moreover, the data store component 206 can store the advertising information (e.g. keywords and/or embedding code fragments) as well. In one embodiment, the request component 202 can request content from the content provider component 204; the content provider component 204 can retrieve the requested content from the data store 206. The content can be analyzed using the advertisement trigger component 102 for possible placements of advertisement data. Upon identifying one or more places, the advertisement association component 104 can associate one or more advertisements with the trigger data and return the content to the request component 202. In another embodiment, the advertising information and/or related code can be existent in the content at the time of request, for example.

The request component 202 can be, for example, a web browser desiring access to one or more media content items (such as a web page, image, movie, and the like). The content provider component 204 can provide access to media content items, which can be stored in the data store 206, for example. It is to be appreciated that the request component 202 can be substantially any device and/or application that can communicate with the content provider component 204, for example. Upon receiving a request for content from the request component 202, the content provider component 204 can access the data store 206 (or substantially any other accessible source, for example) for the requested content. The content can be of a format such that advertisement information can be embedded in the content and displayed upon one or more actions to the content. Such formats can include those mentioned previously (HTML, XML, images, tags, metadata, etc.), for example. During or subsequent access of the content, the advertisement trigger component 102 can evaluate the content for one or more content triggers, such as keywords, sentences, identifiers, image match, and/or the like.

In one embodiment, the data store 206 can hold information regarding the advertisement data, for example, such as one or more content triggers and at least a portion of associated advertisement data and/or code to embed such data in the content. Thus, for example, the data store 206 can hold entries related to advertising for automobiles. One entry in the database can specify a trigger, such as the keyword “Volvo,” for example, along with code to embed a Volvo advertisement. Requested content can be scanned by the advertisement trigger component 102 for the keyword “Volvo” in this example, and the advertisement association component 104 can embed the advertisement code (such as code to display a tooltip advertisement) surrounding the word. In one embodiment, the embedded code can appear seamless to the reader of the content, but an action on the part of the reader (such as a mouse over the word) can cause the ad to be displayed, for instance. In one embodiment, the advertisement can be targeted as well; using this example, an area of the requesting entity can be discerned (such as by IP address or other location identifier) and a local area Volvo dealership ad can be embedded alternatively or in addition. Moreover, other information can be obtained (such as from a profile, for example, which can be stored with the content provider component 204 or accessible by such) and utilized when rendering the advertisement to provide targeted contextual tooltip advertising.

In a text or HTML based configuration, substantially any word or string/combination of words in a document can become an advertisement as it can have associated tooltip ads, for example. Additionally, other configurations can create advertisement in a variety of contexts. For example, substantially any content can become an advertisement, such as those mentioned, but additionally avatars or people and people themselves. Thus, perhaps a person owns their own business or businesses; a profile access can display a business advertisement when a mouse cursor is hovered over the person's avatar or other image, for example.

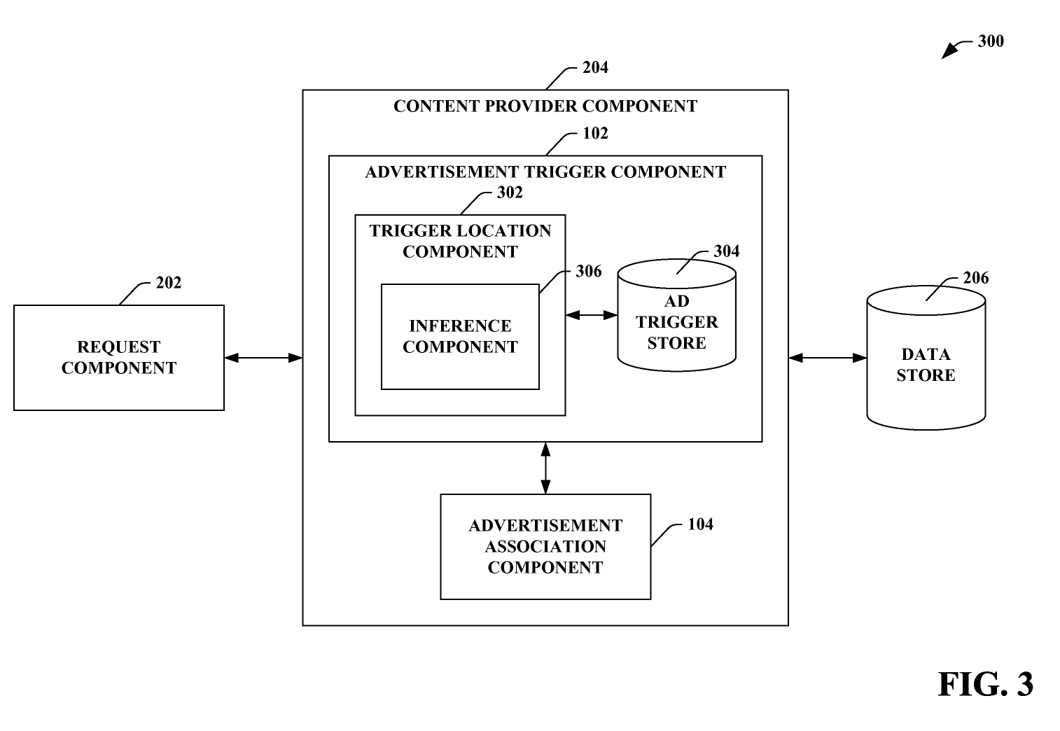

Turning now to FIG. 3, a system 300 for providing content with dynamic tooltip advertisements is displayed. A request component 202 is provided that requests content from a content provider component 204. The content provider component 204 can comprise an advertisement trigger component 102 having a trigger location component 302 that can locate an advertisement trigger in the content explicitly or by utilizing the provided inference component 306, and an ad trigger store 304 that can house one or more advertisement triggers that can indicate possible insertion points in content for advertising information. Additionally, the content provider component 204 can have an advertisement association component 104 that can associate the advertisement code with the trigger in the content. Moreover, a data store 206 can be provided that stores a portion of the content provided by the content provider component 204, for example.

In one embodiment, the request component 202 can request content from the content provider component 204. The content provider component 204 can, for example, access the content from the data store 206. The advertisement trigger component 102 can evaluate the content using trigger location component 302 to find one or more triggers in the content for possible advertisement insertion points. The trigger location component 302 can leverage the ad trigger store 304 to determine one or more triggers for which to search the content. In one example, the trigger(s) can be explicitly provided in the content, such as by metadata, microformats, or substantially any embedded format. Additionally or alternatively, the trigger(s) can be implicitly determined by using the inference component 306 via one or more inference techniques, such as support vector machines, neural networks, expert systems, Bayesian belief networks, fuzzy logic, data fusion engines, classifiers, and the like for example. In this regard, a context can be determined for the content as well as words, sentences, paragraphs, links, images, etc. that can indicate advertisement insertion points. The inferred context can be used to ensure proper ads are associated with the triggers, for example. The inference can be based on historical advertisements, ads used in connection with other content, requested advertisement usage, and the like. The advertisement association component 104 can be subsequently used to associate advertisement information with one or more of the located triggers; this can entail embedding the advertising data within the content, such as in the form of a tooltip, for example. The content can be returned to the request component 202 and when a user thereof moves their mouse cursor over the trigger, the tooltip comprising the advertisement can be displayed, for example.

As described supra, the advertisement triggers can be keywords, sentences, paragraphs, images, tags, metadata, and the like for example. The triggers can be stored in the ad trigger store 304, for example, and content can be evaluated for one or more of the triggers. For example, an image can be a trigger such that the image can be evaluated by the trigger location component 302 against specifications regarding the trigger in the ad trigger store 304. The image can be evaluated against other images such as by using the inference component 306 to perform pattern matching or image registration techniques to determine a similarity. Additionally, the image, or code therefor, can comprise explicit trigger identifiers. To this end, image matching and/or other forms of point matching can be utilized to determine a substantial match in the images causing association of ad information by the advertisement association component 104. Additionally, the image can be evaluated in other regards to determine if it matches a trigger, such as by size, pixels, name, location, etc. If the image matches the trigger, the ad information can be associated by embedding a tooltip within the image and/or within the code that displays the image (such as HTML, in one example). It is to be appreciated that embedding ad information for text and other media can take on a different process achieving substantially similar results in one embodiment.

The ad trigger store 304 can comprise one or more triggers as described above as well as associated advertisement information. In one embodiment, the advertisement information stored in the ad trigger store 304 can be modular such that the advertisement association component 104 can provide code to wrap the advertisement information such that the advertisement trigger component 102, or a component thereof for example, need not know specifics of implementing tooltip or other advertisement displaying functionality. Thus, upon a request for content, the returned content can be evaluated by the advertisement trigger component 102 for one or more triggers. Upon locating triggers, the ad trigger store 304 can be accessed to determine general advertisement information, such as a title, picture, store name, location, and the like, and the advertisement association component 104 can embed the code to display the image within the content, incorporating information from the ad trigger store 304, for example. Additionally, the ad trigger store 304 can associate triggers with partial code, such as XML and/or the like, and the advertisement association component 104 can setup the tooltip functionality, embedding the partial code into the content to allow a definer of the advertisement (and therefore trigger and associated information) to have some control over the presentation of the advertisement, for example.

Furthermore, schemes for embedding advertisements for triggers can be implemented as well, such as for sharing a trigger between a plurality of advertisements. For example, rights to a trigger in a content provider component 204 can be sold as advertisement space to one or more desiring entities. In one embodiment, exclusive rights can be sold for a premium, for example. However, sharing can be implemented such that the trigger location component 302 and/or another component of the advertisement trigger component 102, can cycle through one or more advertisements. This can be done dynamically and/or on a timed, refresh, and/or clicked basis. If done dynamically, the code to dynamically switch the ads can be provided with the trigger in the ad trigger store 304, such that the advertisement association component 104 can embed the code with its own tooltip functioning code and not have to take extra steps to implement the cycling functionality. In this regard, the creator of the advertisement, as additionally shown above, can have some control over the ad presentation, for example. However, this functionality can also be left to the advertisement association component 104 in one embodiment (as described infra).

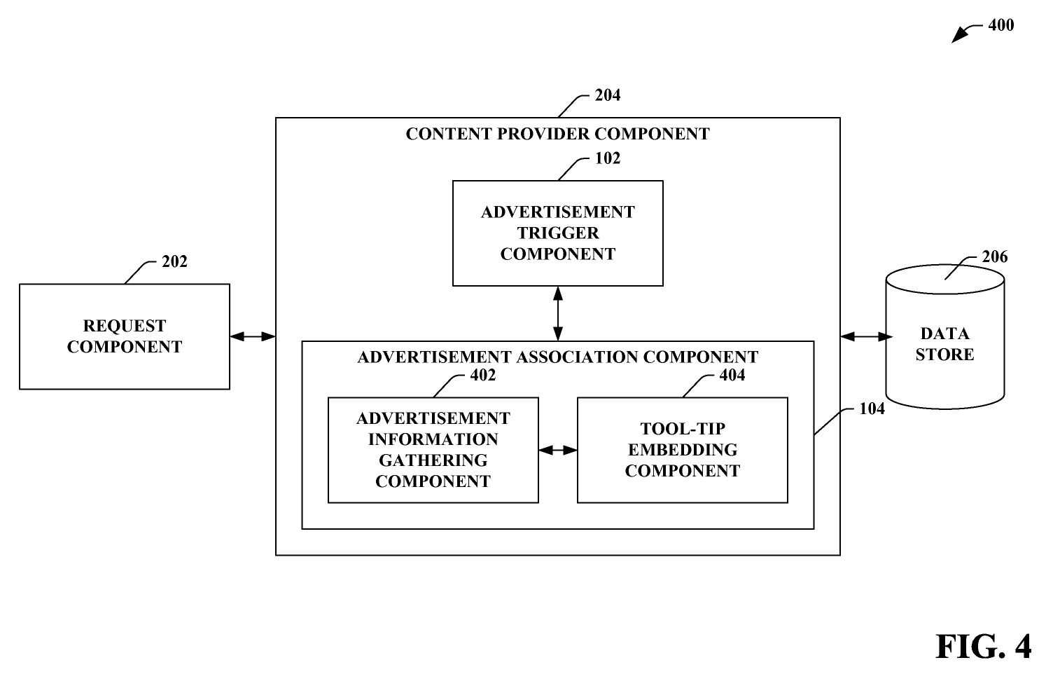

Referring now to FIG. 4, a system 400 that facilitates embedding advertising in content for display as a tooltip is shown. A request component 202 is provided that can request access for content from a content provider component 204. The content provider component 204 can comprise an advertisement trigger component 102 that can analyze content for one or more triggers for insertion of advertising information and an advertisement association component 104 that can associate the advertising information with the trigger. The advertisement association component 104 can have an advertisement information gathering component 402 that can gather and/or receive contextual advertising information relevant to the located trigger and a tooltip embedding component 104 to embed the advertisement as a tooltip related to the trigger in the content. Additionally, a data store 206 is provided to store the served content, for example.

In one embodiment, the request component 202 can make a request for content to the content provider component 204, for example; the content provider component 204 can leverage the data store 206 to gather the desired data. The advertisement trigger component 102 can analyze the content, as described supra, for one or more triggers indicating advertisement insertion points, for example. Upon locating a trigger for an advertisement, the advertisement information gathering component 402 can receive and/or locate advertisement information to be associated with the trigger, for example. In one embodiment, this information, as described, can be modular such that it can be plugged into portions of embeddable code. Additionally, however, the information itself can comprise executable code that can create an advertisement presentation in a given space, for example. The advertisement information can be embedded within the content by the tooltip embedding component 404, and the content can be returned to the request component 202. Upon interaction with the content, tooltip advertisements can be displayed with respect to certain actions occurring on the triggers, such as a mouse cursor rolling over the trigger and/or the trigger coming in window view (as part of a page scroll, for example). The behavior can be inserted by the tooltip embedding component 404, for example; however, the functionality can be self-contained in the content such that the tooltip functionality can occur without further interaction with components of the content provider component 204, for example.

The advertisement information gathering component 402 can be utilized to receive and/or locate information regarding advertisements to be inserted into content, for example. As described, the information can be in a variety of formats and the advertisement information gathering component 402 can support and interpret these formats in a multiple format support embodiment. For example, the advertisement information gathering component 402 can determine whether advertisement information data is a list of fields, one or more database entries, executable code, XML or other hierarchical type code, etc. and properly format the data for embedding into the content. Regardless of or depending on the format, the advertisement information gathering component 402 can ensure proper layout for the tooltip embedding component 404, for example. Moreover, the tooltip embedding component 404 can utilize communication from the advertisement information gathering component concerning the data when embedding the data within the content, in one embodiment. In another embodiment, the tooltip embedding component 404 can embed the data as it is received from the advertisement information gathering component 402, for example. Additionally, the advertisement information gathering component 402 can choose among a plurality of advertisements for embedding where multiple ads are available. For example, where different ads exist for the same words in different contexts (e.g. gas in the automobile fuel context versus gas in the natural gas context), the advertisement information gathering component 402 can choose the appropriate advertisement based at least in part upon a context of the content.

In one example, the request component 202 can desire HTML content from the content provider component 204. The content provider component 204 can access the data store 206 to retrieve the desired HTML and allow the advertisement trigger component 102 to analyze the HTML for triggers indicative of advertisement insertion points. For example, the HTML can be a financial news page and the advertisement trigger component can have advertisements that are to be associated with certain triggers, such as stock tickers and/or company names. The advertisement can relate to one or more brokerage houses for buying stock in certain companies, for example, and can vary based on the trigger or other variables. Upon retrieving the financial news information, the advertisement trigger component 102 can locate one or more company names and/or stock tickers within the document and notify the advertisement association component 104. The advertisement information gathering component 402 can retrieve or receive the advertisement information data and apply any formatting before embedding of the information. Subsequently, the tooltip embedding component 404 can embed the advertisement information within the content using the trigger as an anchor. Thus, the company name and/or stock ticker appears in the content normally when returned to the request component 202, but when an action happens with respect to the trigger during interaction, the tooltip advertisement can be displayed. For example, the tooltip embedded code can display the advertisement upon a mouse cursor touching the company name and/or stock ticker (the trigger). Additionally, other events with respect to the trigger can cause the tooltip to display, such as clicking the trigger, circling the trigger with the mouse cursor, pressing a key on a keyboard, bringing the trigger company name and/or stock ticker within view on a display and/or at a certain position on the display, and the like. In an HTML embodiment, for example, the tooltip embedding component 404 can embed the advertisement to display as a tooltip using executable embeddable code such as a scripting language and the like. Furthermore, substantially any mechanism that the content provider component 204 and/or request component 202 can understand and render can be used to effectuate the functionality at the request component 202 end.

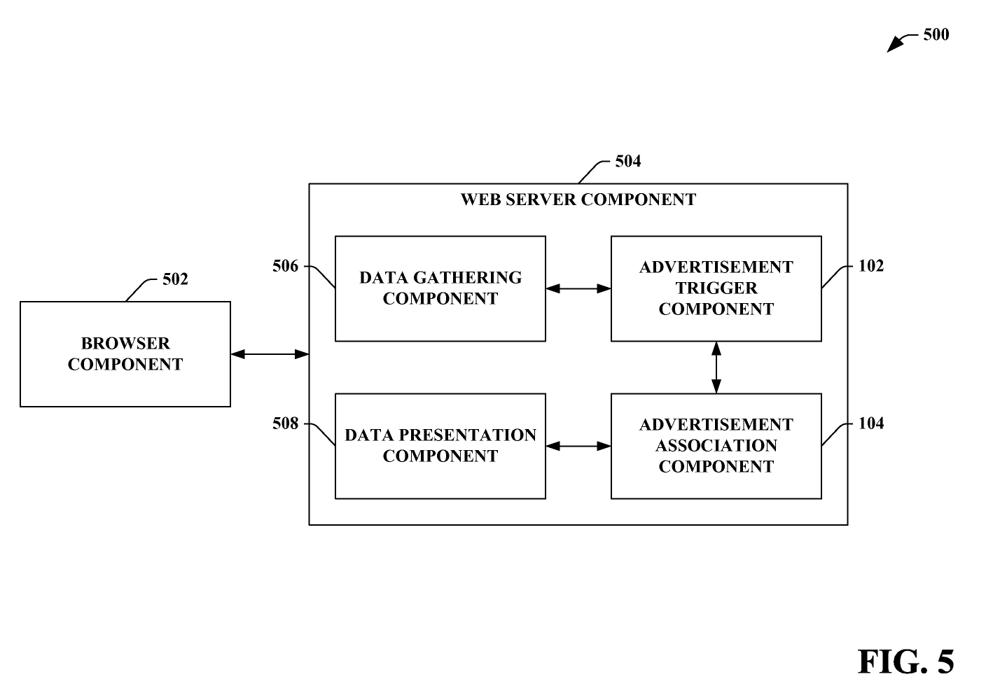

Now referring to FIG. 5, a system 500 is displayed that facilitates serving web content with advertisement tooltip functionality. A browser component 502 is provided that requests one or more web pages or other Internet-based content from a web server component 504. The web server component 504 can serve content such as web pages by utilizing a data gathering component 506 to gather desired data, an advertisement triggering component 102 to locate one or more advertisement triggers for insertion of advertising information by an advertising association component 104, and a data presentation component that can render or otherwise present the web content with the embedded advertisements to the browser component 502, for example.

In one embodiment, the browser component 502 can desire access to web-based content, such as a web page. Upon receiving a request for one or more web pages from the browser component 502, the web server component 504 can gather the page and/or additional data (such as dynamic data) related to the web page using the data gathering component 506. The page(s) can be evaluated for advertisement triggers using the advertisement trigger component 102. The triggers can be defined in the advertisement trigger component 102; in one embodiment, companies can request and/or pay to have advertisements in the advertisement trigger component 102. Additionally, a company can design its own advertisement(s) in one embodiment. The triggers can be keywords, sentences, paragraphs, tags, word combinations, metadata, etc. as explained above, for example. Upon identification of one or more triggers, the advertisement association component 104 can be leveraged, as described herein, to embed advertisement code and/or information within the content to be returned. The data presentation component 506 can subsequently render or otherwise present the web page(s) to the browser component 502. In this regard, the trigger can be utilized as an anchor for the embedded advertisement such that the trigger can otherwise appear normally in the rendered page(s), but an action taken can result in a tooltip type functioning advertisement popping-up upon action to the anchor/trigger, for example.

As described, the advertisement association component 104 can embed web pages with scripting code (such as JavaScript, for example) for displaying the tooltip advertisements at the browser component 502 end. In this regard, the functionality can be in the web page such that the browser component 502 need not necessarily access the web server component 504 to effectuate display of the tooltip advertisement. Rather, the browser component 502 can have the functionality to render the code for the tooltip advertisements such that the web server component 504 need only insert the code in the web page and the browser component 502 can handle the actions and appropriately display the advertising information. In one embodiment, the advertisements can be targets to the keywords in the document, for example, and/or in regard to other contexts so that they correlate to the subject of the context. For example, where the content is a web page regarding automobiles, the word “brake” can render a different tooltip type advertisement than a web page regarding machinery as the brakes in the two fields typically come from different manufacturers in different configurations.

Furthermore, advertisements can be dynamic such that the advertisement information provided to the advertisement trigger component 102 for association with a trigger and/or code of the advertisement association component 104 can change the advertisement information for certain events (such as for each mouse over). In this case, advertisement space can be shared such that hovering a mouse cursor over a word can produce different ads, such as by hover count, timer, clicking, and/or the like. Additionally, the ads can be from different or the same ad space purchaser, for example. The code provided, either in the ad information received from the ad purchaser or in the advertisement association component 104, can be scripting code implemented to provide this functionality. The scripting code can be embedded in the web page(s) upon accessing, for example, and in one embodiment, the browser component 502 can appropriately render the ads according to the code. In another embodiment, the ads can be cycled by the advertisement association component 104 for a more static representation of the information.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent, for instance by inferring actions based on contextual information. By way of example and not limitation, such mechanism can be employed with respect to generation of materialized views and the like.

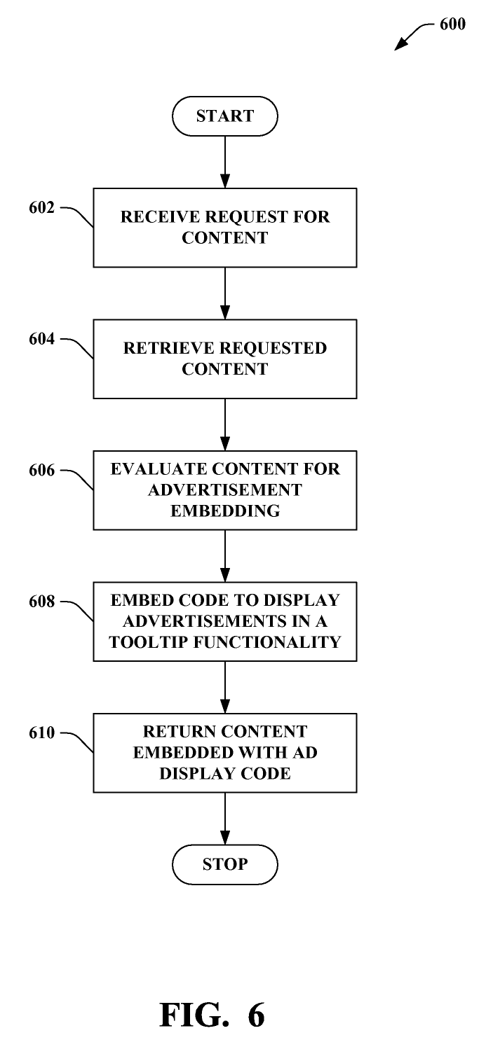

In view of the exemplary systems described supra, methodologies that may be implemented in accordance with the disclosed subject matter will be better appreciated with reference to the flow charts of FIGS. 6-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 6 shows a methodology 600 for providing content with embedded advertising display code. At 602, a request for content is received. As described supra, the request can be for substantially any media content such as text, HTML, XML, images, metadata, tags, videos, etc. At 604, the requested content is retrieved; this can be from a data store and/or substantially any location accessible by the retrieving component, for example. At 606, the content can be evaluated for advertisement embedding. This can entail attempting to locate content within the content that can relate to one or more available advertisements. For example, the content can be HTML and can comprise keywords or tags/data values that can relate to certain stored advertisements. Additionally, the content can be an image or the like where advertising can be associated based on a matching of the image, a location, file name, size, etc. It is to be appreciated that content can have many points of insertion for advertisement based in part on the ads available and the content type; mechanisms for inserting the advertisements can be specific for each content type, in one embodiment.

At 608, code is embedded within the content to display advertisements using tooltip type functionality. In this regard, when a trigger/anchor portion of the content (the content earlier identified as a point of insertion for the advertisement) is hovered over with a cursor, the advertisement can be displayed in a pop-type box. In the HTML example, the code can be a scripting language segment inserted around the keyword such that hovering over the keyword with a cursor displays the advertisement. In the image example, the image can be a scalable vector graphic (SVG) image, or some other image type that allows association of dynamic data, for example, and additional SVG code can be embedded within the original SVG to display a tooltip box upon hovering a cursor over the image or a portion thereof. At 610, the content embedded with the advertisement display code is returned to the requesting entity to effectuate the aforementioned behavior. In this regard, the client that receives the content can have the ability to properly render the tooltip advertisement functionality, for example.

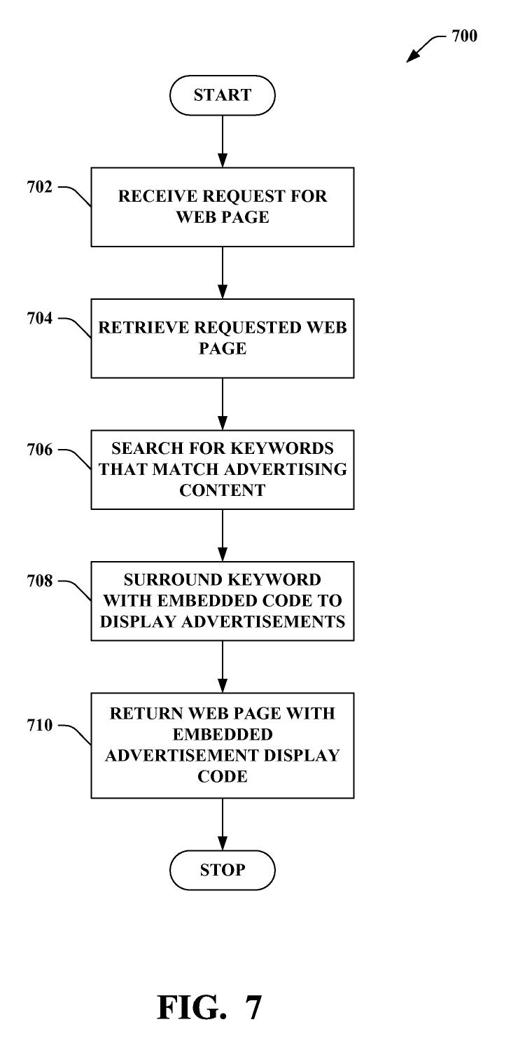

FIG. 7 illustrates a methodology 700 that facilitates associating tooltip advertisement code with web pages. At 702, a request for a web page is received. This can be a request that accesses a plurality of sources and stores to formulate a web page, for example, such as a news page, a financial page, a web logging (blog) page, and/or the like. At 704, the page is retrieved, which can include aggregating data from one or more sources to fulfill the request. Once the page is prepared, at 706, it can be searched for keywords that match advertising content. In this regard, there can be a storage of advertising content having associated keywords. For example, words in the web page can be sold for advertising space. Thus, when a word from the store is encountered in a web page, advertisement information can be related to the occurrence of the word, for example. It is to be appreciated that different contexts can apply to the same word, as described supra, and appropriate advertisement material can be chosen in those (or other) cases. Additionally, mechanisms can allow multiple ads to be displayed together or in a cycling manner to facilitate ad space sharing.

At 708, keywords that match one or more advertisement keywords in the storage can be surrounded by embedded code to display advertisements when actions occur on the keyword after rendering the requested web page. In this regard, the keyword can become an anchor for the advertising code such that the keyword can appear unaffected when viewing the resulting web page; however hovering a cursor over a keyword can display or cause execution of the embedded advertisement code, for example. At 710, the web page is returned with the embedded advertisement display code to effectuate the aforementioned functionality. In this way, advertisements can be related to the content of the web page, but displayed upon hovering a cursor over a keyword to which the advertisement relates, for example.

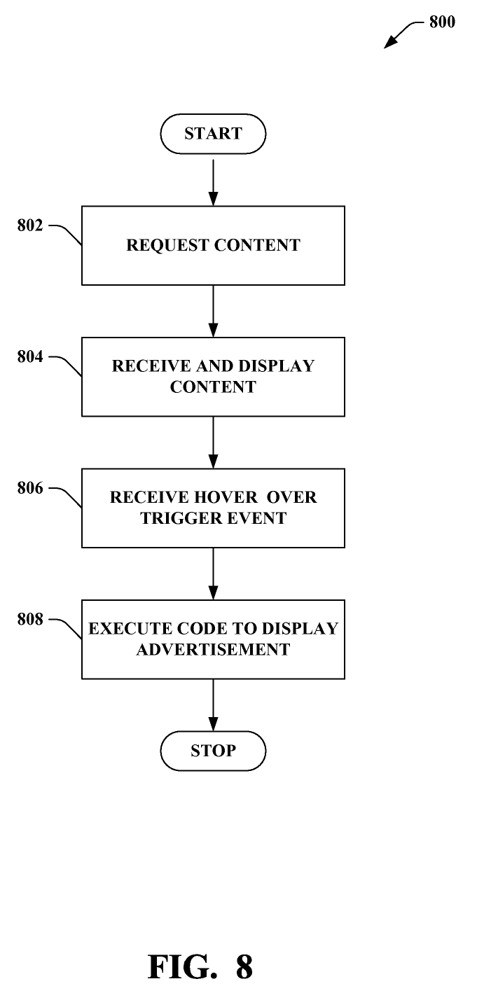

FIG. 8 shows a methodology 800 for requesting content and rendering embedded advertising upon occurrence of a hovering event. At 802, content is requested, such as on behalf of a user, for example. The content can be substantially any media content as described above. At 804, the content is received and displayed. It is to be appreciated that the content can comprise embedded code for displaying advertising upon certain events to the displayed content. However, the content can appear without advertising until occurrence of the event. In one embodiment, the content can be a web page and the text can appear in substantially the same manner as if embedded advertising were not present (in one embodiment, anchor keywords that have embedded advertising can be underlined or otherwise identified).

At 806, a hover over event can be received such that a viewer of the displayed content hovered a cursor over a trigger and/or anchor that has associated advertising content. In one embodiment, script code (such as in an HTML implementation) can execute to detect the occurrence of the event, for example). It is to be appreciated that the engine/mechanism for detecting and/or handling such events can exist on the client or requesting side, for example. At 808, the code to display the advertisement in a tooltip manner is executed. The tooltip can appear near to the mouse cursor and can comprise the advertisement. Thus, contextual advertising is facilitated for hovering over keywords or other triggers in media content. It is to be appreciated that the advertisement code can be substantially coded and designed by the provider of the advertisement, in one embodiment.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally, it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

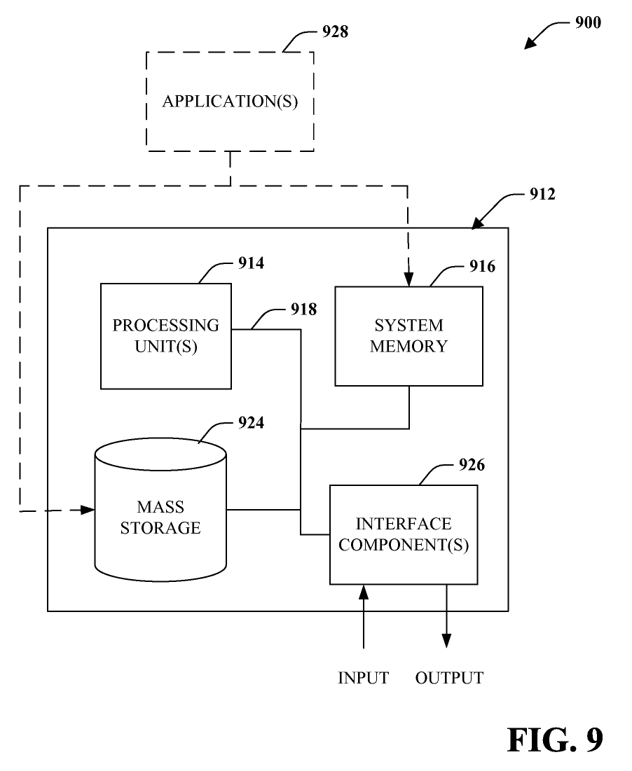

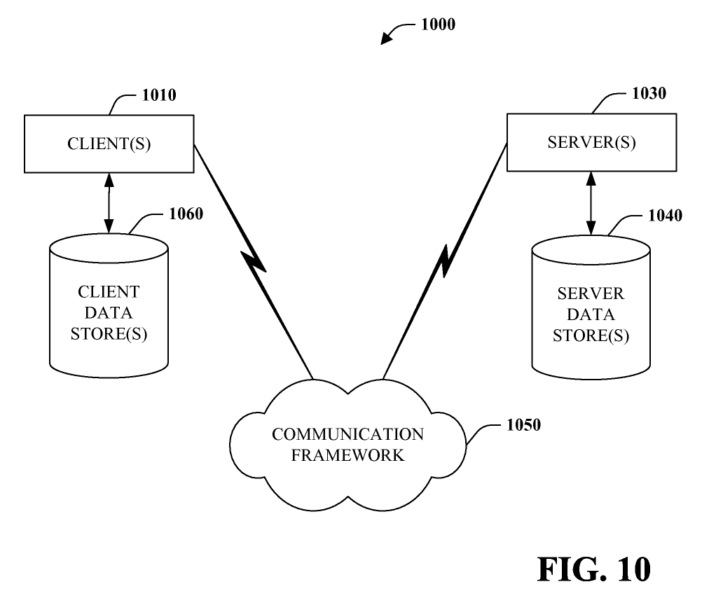

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 9, an exemplary environment 900 for implementing various aspects disclosed herein includes a computer 912 (e.g., desktop, laptop, server, hand held, programmable consumer or industrial electronics . . . ). The computer 912 includes a processing unit 914, a system memory 916 and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory or memory stick. In addition, mass storage 924 can include storage media separately or in combination with other storage media.

FIG. 9 provides software application(s) 928 that act as an intermediary between users and/or other computers and the basic computer resources described in suitable operating environment 900. Such software application(s) 928 include one or both of system and application software. System software can include an operating system, which can be stored on mass storage 924, that acts to control and allocate resources of the computer system 912. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., CRT, LCD, plasma . . . ), speakers, printers and other computers, among other things.

FIG. 10 is a schematic block diagram of a sample-computing environment 1000 with which the subject innovation can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. Here, the client(s) 1010 can correspond to program application components and the server(s) 1030 can provide the functionality of the interface and optionally the storage system, as previously described. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

By way of example, one or more clients 1010 can request content from the one or more servers 1030, for example, via communication framework 1050. The servers 1030 can gather the requested content from the server data stores 1040 and evaluate the content for one or more triggers for insertion of advertising. Upon location of such a trigger, the content can be embedded with code to display advertising information in a tooltip display format. The content with the embedded code can be sent back to the clients 1010 via communication framework 1050, for example. Upon receiving and displaying the content, the clients 1010 can interpret the code provided therein to effectuate tooltip type displaying of advertisements when the triggers are hovered over with a mouse cursor, for example. Additionally, the clients 1010 can store information, such as the returned content, in local data stores 1060, for example.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A system for providing contextual tooltip type advertisements within content, comprising:
an advertisement trigger component that detects one or more triggers within content for inserting at least one advertisement; and
an advertisement association component that embeds the advertisement with the trigger within the content such that the advertisement is displayed in a tooltip manner upon a cursor hovering over the trigger.

2. The system of claim 1, further comprising an ad store that associates the advertisement with the trigger in one or more entries in the ad store.

3. The system of claim 2, the advertisement and associated trigger are provided by a third-party.

4. The system of claim 2, the advertisement trigger component detects the trigger within the content based at least in part on the one or more entries in the ad store.

5. The system of claim 1, the advertisement association component chooses the advertisement based on a context of the content and/or usage of the trigger within the content.

6. The system of claim 1, the trigger is a keyword in the content to which the advertisement relates.

7. The system of claim 1, the trigger is a portion of the content that remains visibly unaffected by the embedded advertisement when the cursor is hovering elsewhere.

8. The system of claim 1, the content is a hypertext markup language (HTML) web page.

9. The system of claim 8, the advertisement is embedded within the web page along with script code to effectuate the tooltip display manner of the advertisement.

10. A method for rendering contextual advertisements in connection with content using tooltip type display functionality, comprising:
retrieving content in response to a request;
embedding one or more advertisements within the content using one or more portions of the content as triggers for displaying the advertisements in a tooltip display format; and
returning the content with the advertisements substantially hidden.

11. The method of claim 10, further comprising displaying the one or more advertisements in a tooltip display format upon hovering a cursor over the trigger portion of the content.

12. The method of claim 10, the trigger is an image, the advertisement is embedded such that hovering a cursor over the image and/or a portion thereof displays the one or more advertisements in a tooltip display format.

13. The method of claim 12, the image is matched to an image related to the advertisement.

14. The method of claim 10, further comprising evaluating the content against a storage for advertisements and associated triggers to determine which advertisements to embed.

15. The method of claim 14, further comprising evaluating the content in a context to decide between one or more advertisements for the same trigger.

16. The method of claim 14, further comprising populating the storage for advertisements and associated triggers according to a purchase of ad space.

17. The method of claim 10, the content is hypertext markup language (HTML) and the advertisement is embedded with a scripting language using the trigger as an anchor.

18. The method of claim 17, the content is embedded with additional scripting code to effectuate the tooltip display functionality.

19. A system for embedding contextual advertisements in content for display as a tooltip, comprising:
means for evaluating content against a data store having advertisements and associated triggers for locating one or more of the triggers; and
means for embedding code within the content to display one or more advertisements from the data store that relate to the one or more triggers in a tooltip display manner.

20. The system of claim 19, further comprising means for returning the content with the embedded code to one or more requesting clients, the one or more requesting clients can interpret the code to properly display the advertisement in the tooltip display manner upon occurrence of an event to the one or more triggers.
